(19) United States
(12) Patent Application Publication
(10) Pub. No.: US 2026/0275529 A1
(43) Pub. Date: Sep. 17, 2026

(54) GRAIN-ORIENTED ELECTRICAL STEEL SHEET AND METHOD FOR FORMING INSULATING COATING

(71) Applicant: NIPPON STEEL CORPORATION, Tokyo (JP)

(72) Inventors: Kazutoshi TAKEDA, Tokyo (JP); Shinsuke TAKATANI, Tokyo (JP); Takashi KATAOKA, Tokyo (JP); Yuuki KOGAKURA, Tokyo (JP)

(73) Assignee: NIPPON STEEL CORPORATION, Tokyo (JP)

(21) Appl. No.: 19/473,195

(22) PCT Filed: Apr. 12, 2024
(86) PCT No.: PCT/JP2024/014857

§ 371 Date: Oct. 7, 2025

(30) Foreign Application Priority Data
Apr. 12, 2023 (JP) 2023-064840

(51) Int. Cl. C23C 28/04; C21D 8/0221; C21D 8/0247; C21D 8/0278; C22C 38/00; C22C 38/02; C22C 38/04; C22C 38/06; C23C 30/00; C25D 3/22; C25D 3/54; C25D 5/36; C25D 5/48

(52) U.S. Cl. CPC C23C 28/04; C21D 8/0226; C21D 8/0236; C21D 8/0273; C21D 8/0284; C21D 8/0289; C22C 38/001; C22C 38/002; C22C 38/02; C22C 38/04; C22C 38/06; C23C 30/005; C25D 3/22; C25D 3/54; C25D 5/36; C25D 5/48; C21D 2201/05

(57) ABSTRACT

The grain-oriented electrical steel sheet includes: a base steel sheet; and an insulating coating formed on a surface of the base steel sheet, in which the insulating coating includes: an intermediate layer that is formed on a side of the base steel sheet and contains a crystalline metal phosphate; and a tension coating layer formed on a surface side of the insulating coating, and the crystalline metal phosphate is plate-shaped, and has an average grain size of 0.5 to 3.0 μm.

### TECHNICAL FIELD

The present invention relates to a grain-oriented electrical steel sheet and a method for forming an insulating coating.

Priority is claimed on Japanese Patent Application No. 2023-064840, filed Apr. 12, 2023, the content of which is incorporated herein by reference.

### BACKGROUND ART

A grain-oriented electrical steel sheet is mainly used for a transformer. The transformer is continuously magnetized for a long period of time from installation to disposal and continues to generate energy loss. Therefore, energy loss when the transformer is magnetized by alternating current, that is, iron loss, is a main index for determining performance of the transformer.

In order to reduce the iron loss of the grain-oriented electrical steel sheet, many techniques have been developed so far from the viewpoint of (a) increasing development in the {110}<001> orientation (Goss orientation), (b) increasing the amount of a solid solution element such as Si to increase the electric resistance of the steel sheet, or (c) reducing the sheet thickness of the electrical steel sheet.

In addition, applying tension to the steel sheet is effective for reducing iron loss. It is an effective means for reducing iron loss to form a coating made of a material having a thermal expansion coefficient smaller than that of the steel sheet on a sheet surface at a high temperature. A forsterite-based coating (inorganic coating) having excellent coating adhesion, generated by a reaction between an oxide on a sheet surface and an annealing separator in a finishing annealing step of an electrical steel sheet, is a coating capable of applying tension to the steel sheet.

For example, a method for forming an insulating coating by baking a coating liquid mainly containing colloidal silica and a phosphate on a sheet surface, disclosed in Patent Document 1, is an effective method for reducing iron loss because the method has a large effect of applying tension to the steel sheet. Therefore, a general method for manufacturing a grain-oriented electrical steel sheet is to leave the forsterite-based coating generated in the finishing annealing step and to form an insulating coating mainly containing a phosphate on the forsterite-based coating.

However, in recent years, there has been an increasing demand for miniaturization and high performance of a transformer, and in order to miniaturize the transformer, a grain-oriented electrical steel sheet is required to have excellent high magnetic field iron loss such that iron loss is favorable even when magnetic flux density is high. At the same time, in recent years, it has been clarified that the forsterite-based coating hinders movement of a domain wall and adversely affects iron loss. In a grain-oriented electrical steel sheet, a magnetic domain changes by movement of a domain wall under an alternating magnetic field. Smooth and rapid movement of the domain wall is effective for reducing iron loss, but the forsterite-based coating itself is a non-magnetic body and has an uneven structure at a steel sheet/coating interface, and this uneven structure hinders movement of the domain wall. Therefore, it is considered that the forsterite-based coating adversely affects iron loss.

Therefore, as a means for improving high magnetic field iron loss, a technique for manufacturing a grain-oriented electrical steel sheet having no forsterite-based coating, or a technique for bringing a sheet surface into a mirror surface state (in other words, a technique for magnetically smoothing a sheet surface) have been studied by: a method of removing a forsterite-based coating by using a mechanical means such as polishing or a chemical means such as pickling; or preventing generation of a forsterite-based coating in high-temperature finishing annealing.

As a technique for preventing generation of a forsterite-based coating, for example, Patent Document 2 discloses a technique in which a surface-formed product is removed by pickling after normal finishing annealing, and then the sheet surface is brought into a mirror surface state by chemical polishing or electrolytic polishing. It has been found that a better iron loss improving effect can be obtained by forming a tension-applying insulating coating on the surface of a grain-oriented electrical steel sheet without a forsterite-based coating, obtained by such a known method. In addition, the tension-applying insulating coating can impart various characteristics such as corrosion resistance, heat resistance, and slippage, in addition to improvement of iron loss.

However, the forsterite-based coating has an effect of exhibiting insulation properties and an effect as an intermediate layer for ensuring adhesion when a tension coating (tension-applying insulating coating) is formed. That is, since the forsterite-based coating is formed in a state of deeply entering the steel sheet, the forsterite-based coating is excellent in adhesion to the steel sheet, which is metal. Therefore, when a tension-applying type coating (tension coating) containing colloidal silica, a phosphate, or the like as a main component is formed on the surface of the forsterite-based coating, coating adhesion is excellent. On the other hand, since it is generally difficult to bond metal and oxide to each other, it is difficult to ensure sufficient adhesion between the tension coating and the surface of a steel sheet when the forsterite-based coating is not present.

Therefore, in a case where a tension coating is formed on a grain-oriented electrical steel sheet having no forsterite-based coating, it has been studied to form a layer that alternatively plays a role as an intermediate layer of the forsterite-based coating.

For example, Patent Document 3 discloses a technique in which a grain-oriented electrical steel sheet having no forsterite-based coating (inorganic coating) is annealed in a weakly reducing atmosphere, and silicon inevitably contained in a silicon steel sheet is thermally oxidized selectively to form a SiO₂ layer on the sheet surface, and then a tension-applying type insulating coating is formed. Patent Document 4 discloses a technique in which a grain-oriented electrical steel sheet having no forsterite-based coating (inorganic coating) is subjected to an anodic electrolytic treatment in a silicate aqueous solution to form a SiO₂ layer on the sheet surface, and then a tension-applying type insulating coating is formed.

However, in the technique disclosed in Patent Document 3, it is necessary to prepare an annealing facility capable of controlling an atmosphere in order to perform annealing in a weakly reducing atmosphere, and there is a problem in treatment cost. In the technique disclosed in Patent Document 4, it is necessary to prepare a new electrolysis treatment facility in order to obtain a SiO₂ layer that maintains sufficient adhesion to a tension-applying type insulating coating on a sheet surface by performing an anodic electrolytic treatment in a silicate aqueous solution, and there is a problem in treatment cost.

On the other hand, Patent Document 5 discloses a grain-oriented electrical steel sheet including: a base steel sheet; and an insulating coating formed on the surface of the base steel sheet, in which the insulating coating includes: an intermediate layer that is formed on the side of the base steel sheet and contains a crystalline metal phosphate; and a tension coating layer formed on the surface side of the insulating coating. In the grain-oriented electrical steel sheet, the intermediate layer can be formed by chemical conversion treatment.

### CITATION LIST

### Patent Document

Patent Document 1: Japanese Unexamined Patent Application, First Publication No. S48-039338
Patent Document 2: Japanese Unexamined Patent Application, First Publication No. S49-96920
Patent Document 3: Japanese Unexamined Patent Application, First Publication No. H06-184762
Patent Document 4: Japanese Unexamined Patent Application, First Publication No. H11-209891
Patent Document 5: PCT International Publication No. WO 2022/215709

### SUMMARY OF INVENTION

### Technical Problem

In the technique of Patent Document 5, coating adhesion, coating tension, and magnetic characteristics can be improved by the intermediate layer made of a crystalline metal phosphate included between the base steel sheet and the tension coating. In addition, since the intermediate layer can be formed by chemical conversion treatment, no special equipment is required. Therefore, the technique is useful.

On the other hand, in the technique of Patent Document 5, there is a problem that the productivity becomes poor when the adhesion is further improved. This is because it takes time to precipitate a crystalline metal phosphate by chemical conversion treatment.

In order to solve the above problem, it is conceivable to precipitate a crystalline metal phosphate by electrolytic chemical conversion treatment. However, when an attempt is made to form a crystalline metal phosphate layer by an electrolytic chemical conversion treatment on the surface of a grain-oriented electrical steel sheet having no forsterite-based coating, the crystal of the metal phosphate may become coarse. When the crystal of the metal phosphate increases in size, the actually manufactured transformer has a reduced space factor.

Therefore, an object of the present invention is to provide a grain-oriented electrical steel sheet that has a layer containing a metal phosphate formed by chemical conversion treatment on the surface of a steel sheet having no forsterite-based coating, is excellent in adhesion with a tension coating and magnetic characteristics, and does not reduce the space factor of a transformer (core). However, it is assumed that basic characteristics required for a coating, such as corrosion resistance and phosphoric acid elution resistance, are not deteriorated.

### Solution to Problem

Assuming a method for forming a crystalline metal phosphate layer by an electrolytic chemical conversion treatment on the surface of a grain-oriented electrical steel sheet having no forsterite-based coating, the present inventors have studied a method for obtaining a grain-oriented electrical steel sheet that is excellent in adhesion with a tension coating and magnetic characteristics and does not reduce the space factor of a transformer (core). As a result, it has been found that an electrolytic chemical conversion treatment is performed with a treatment liquid whose metal ion concentration, phosphate ion concentration, and nitrate ion concentration are in specific ranges, and the electrolytic chemical conversion treatment is performed at a specific current density, and thereby coarsening of the crystalline metal phosphate can be suppressed. In addition, it has been found that the grain-oriented electrical steel sheet having such a crystalline metal phosphate layer is excellent in adhesion with a tension coating and magnetism and increases the space factor of a transformer.

The present invention has been made in view of the above findings. The gist of the present invention is as follows.
[1] In an embodiment of the present invention, a grain-oriented electrical steel sheet includes: a base steel sheet; and an insulating coating formed on a surface of the base steel sheet, in which the insulating coating includes: an intermediate layer that is formed on a side of the base steel sheet and contains a crystalline metal phosphate; and a tension coating layer formed on a surface side of the insulating coating, and the crystalline metal phosphate is plate-shaped, and has an average grain size of 0.5 to 3.0 μm.
[2] In the grain-oriented electrical steel sheet according to [1], in the intermediate layer, the crystalline metal phosphate may include at least one of zinc phosphate, manganese phosphate, manganese iron phosphate, and calcium zinc phosphate.
[3] In the grain-oriented electrical steel sheet according to [1], the intermediate layer may have a thickness of 0.1 to 9.0 μm.
[4] In an embodiment of the present invention, a method for forming an insulating coating, which is a method for forming the insulating coating included in the grain-oriented electrical steel sheet according to [1], includes: a finishing annealing step of applying an annealing separator containing Al₂O₃ in an amount of 10 to 100 mass % onto a steel sheet, drying the steel sheet, and then finishing annealing the steel sheet; an annealing separator removing step of removing an excess of the annealing separator from the steel sheet after the finishing annealing step; a light pickling step of pickling the steel sheet after the annealing separator removing step with 0.1 to 10.0 mass % of one inorganic acid selected from sulfuric acid, chloric acid, nitric acid, and phosphoric acid at a liquid temperature of 20 to 90° C. for 1 to 20 seconds; an intermediate layer forming step of washing the steel sheet after the light pickling step with water, and then energizing the steel sheet for 3 to 30 seconds at a current density of 1.0 to 50 A/dm² in a mixed treatment liquid having a metal ion concentration of 10 to 50 g/l, a phosphate ion concentration of 10 to 100 g/l, and a nitrate ion concentration of 20 to 80 g/l at a liquid temperature of 30 to 90° C.; a drying step of pulling up the steel sheet after the intermediate layer forming step from the mixed treatment liquid, removing an excess of the mixed treatment liquid, and then drying the steel sheet; and a tension coating layer forming step of applying a coating liquid containing a metal phosphate and colloidal silica, the metal phosphate and the colloidal silica contained in a total concentration of 10 to 40 mass %, to the steel sheet after the drying step, drying the steel sheet, and then heating and holding the steel sheet at a sheet temperature of 700 to 950° C. for 10 to 60 seconds.

### Advantageous Effects of Invention

According to the present invention, it is possible to provide a grain-oriented electrical steel sheet that is excellent in adhesion with a tension coating and magnetic characteristics, and does not reduce the space factor of a transformer (core).

### BRIEF DESCRIPTION OF DRAWINGS

FIG. 1 An example of a cross-sectional view of a grain-oriented electrical steel sheet according to the embodiment.

### DESCRIPTION OF EMBODIMENTS

The grain-oriented electrical steel sheet according to an embodiment of the present invention (grain-oriented electrical steel sheet according to the embodiment) and a manufacturing method of a grain-oriented electrical steel sheet according to the embodiment, the method including a method for forming an insulating coating included in the grain-oriented electrical steel sheet according to the embodiment, will be described.

First, the grain-oriented electrical steel sheet according to the embodiment will be described.

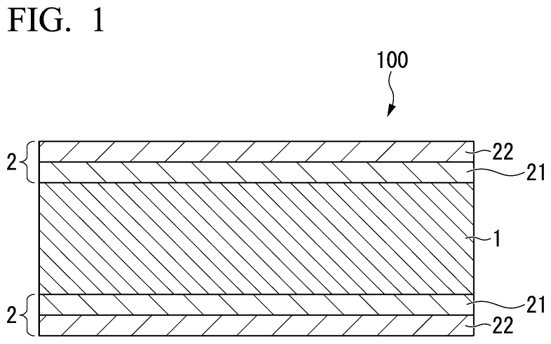

As illustrated in FIG. 1, a grain-oriented electrical steel sheet 100 according to the embodiment has a base steel sheet 1 and an insulating coating 2 formed on the surface of the base steel sheet 1. In the grain-oriented electrical steel sheet 100 according to the embodiment, a forsterite-based coating is not intentionally formed on the surface of the base steel sheet 1, and no forsterite-based coating is usually present. However, when the coating amount of the forsterite-based coating is 1.0 g/m² or less, the presence thereof is allowed (in this case, in a part between the base steel sheet 1 and the insulating coating 2).

The insulating coating 2 has a tension coating layer 22 formed on the surface side of the insulating coating 2 (that is, the surface side of the grain-oriented electrical steel sheet 100), and an intermediate layer 21 formed on the base steel sheet 1 side and containing a crystalline metal phosphate.

In addition, in the intermediate layer 21, the crystalline metal phosphate is plate-shaped, and has an average grain size of 0.5 to 3.0 μm.

Each will be described below.

### <Base Steel Sheet>

### (Chemical Composition)

The grain-oriented electrical steel sheet 100 according to the embodiment has a significant feature in the structure of the insulating coating 2 formed on the surface of the base steel sheet 1. The chemical composition of the base steel sheet 1 included in the grain-oriented electrical steel sheet 100 is not limited. However, in order to obtain characteristics generally required for a grain-oriented electrical steel sheet, the base steel sheet 1 preferably contains the following components as a chemical composition. In the embodiment, % relating to the chemical composition is mass % unless otherwise specified.

### C: 0.010% or Less

C (carbon) is an element effective in controlling the microstructure of the steel sheet in steps before the completion of the decarburization annealing step in the manufacturing process. However, when the C content exceeds 0.010%, the magnetic characteristics of the grain-oriented electrical steel sheet, which is a product sheet, are deteriorated. Therefore, in the base steel sheet of the grain-oriented electrical steel sheet according to the embodiment, the C content is preferably 0.010% or less. The C content is more preferably 0.005% or less. The C content is preferably as low as possible, but even when the C content is reduced to less than 0.0001%, the microstructure control effect is saturated, and manufacturing cost is merely increased. Therefore, the C content may be 0.0001% or more.

### Si: 2.50 to 4.00%

Si (silicon) is an element that increases the electric resistance of the grain-oriented electrical steel sheet and improves iron loss characteristics. When the Si content is less than 2.50%, a sufficient eddy-current loss reducing effect cannot be obtained. Therefore, the Si content is preferably 2.50% or more. The Si content is more preferably 2.70% or more, and still more preferably 3.00% or more.

On the other hand, when the Si content exceeds 4.00%, the grain-oriented electrical steel sheet is embrittled, and passability is significantly deteriorated. In addition, workability of the grain-oriented electrical steel sheet is deteriorated, and the steel sheet may be fractured during rolling. Therefore, the Si content is preferably 4.00% or less. The Si content is more preferably 3.80% or less, and still more preferably 3.70% or less.

### Mn: 0.01 to 0.50%

Mn (manganese) is an element that is bonded to S in the manufacturing process to form MnS. This precipitate functions as an inhibitor (inhibitor of normal grain growth) and causes secondary recrystallization in steel. Mn is also an element that enhances hot workability of steel. When the Mn content is less than 0.01%, the above effect cannot be sufficiently obtained. Therefore, the Mn content is preferably 0.01% or more. The Mn content is more preferably 0.02% or more.

On the other hand, when the Mn content exceeds 0.50%, secondary recrystallization does not occur, and the magnetic characteristics of steel are deteriorated. Therefore, in the base steel sheet of the grain-oriented electrical steel sheet according to the embodiment, the Mn content is preferably 0.50% or less. The Mn content is more preferably 0.20% or less, and still more preferably 0.10% or less.

### N: 0.010% or Less

N (nitrogen) is an element that is bonded to Al in the manufacturing process to form AlN that functions as an inhibitor. However, when the N content is more than 0.010%, the inhibitor excessively remains in the grain-oriented electrical steel sheet, and the magnetic characteristics are deteriorated. Therefore, in the base steel sheet of the grain-oriented electrical steel sheet according to the embodiment, the N content is preferably 0.010% or less. The N content is more preferably 0.008% or less.

On the other hand, the lower limit of the N content is not particularly limited, but even when the N content is reduced to less than 0.001%, manufacturing cost is merely increased. Therefore, the N content may be 0.001% or more.

Sol. Al: 0.020% or Less

Sol. Al (acid-soluble aluminum) is an element that is bonded to N in the manufacturing process of the grain-oriented electrical steel sheet to form AlN that functions as an inhibitor. However, when the sol. Al content in the base steel sheet exceeds 0.020%, the inhibitor excessively remains in the base steel sheet to deteriorate magnetic characteristics. Therefore, in the base steel sheet of the grain-oriented electrical steel sheet according to the embodiment, the sol. Al content is preferably 0.020% or less. The sol. Al content is more preferably 0.010% or less, and still more preferably less than 0.001%. The lower limit of the sol. Al content is not particularly limited, but even when the content is reduced to less than 0.0001%, manufacturing cost is merely increased. Therefore, the sol. Al content may be 0.0001% or more.

### S: 0.010% or Less

S (sulfur) is an element that is bonded to Mn in the manufacturing process to form MnS that functions as an inhibitor. However, when the S content exceeds 0.010%, the remaining inhibitor deteriorates magnetic characteristics. Therefore, in the base steel sheet of the grain-oriented electrical steel sheet according to the embodiment, the S content is preferably 0.010% or less. The S content in the grain-oriented electrical steel sheet is more preferably as low as possible. For example, the S content is less than 0.001%. However, even when the S content is reduced to less than 0.0001% in the grain-oriented electrical steel sheet, manufacturing cost is merely increased. Therefore, the S content may be 0.0001% or more in the grain-oriented electrical steel sheet.

### Balance: Fe and Impurities

The chemical composition of the base steel sheet of the grain-oriented electrical steel sheet according to the embodiment may contain the above-described elements, with the balance being Fe and impurities. However, the base steel sheet may further contain Sn, Cu, Se, and Sb in the following ranges for the purpose of improving magnetic characteristics and the like. In addition, for example, even when the base steel sheet contains any one or more of W, Nb, Ti, Ni, Co, V, Cr, and Mo in a total amount of 1.0% or less as elements other than these elements, the effect of the grain-oriented electrical steel sheet according to the embodiment is not impaired.

Here, the impurities are contaminated from ore or scrap as a raw material, or from a manufacturing environment or the like when the base steel sheet is industrially manufactured. The impurities mean elements allowed to be included in such an amount that the action of the grain-oriented electrical steel sheet according to the embodiment is not adversely affected.

### Sn: 0 to 0.50%

Sn (tin) is an element that contributes to improvement in magnetic characteristics through primary recrystallization structure control. In order to obtain an effect of improving magnetic characteristics, the Sn content is preferably 0.01% or more. The Sn content is more preferably 0.02% or more, and still more preferably 0.03% or more.

On the other hand, when the Sn content exceeds 0.50%, secondary recrystallization is unstable, and magnetic characteristics are deteriorated. Therefore, the Sn content is preferably 0.50% or less. The Sn content is more preferably 0.30% or less, and still more preferably 0.10% or less.

### Cu: 0 to 0.50%

Copper (Cu) is an element that contributes to an increase in Goss orientation occupancy in a secondary recrystallization structure. In order to obtain the above effect, the Cu content is preferably 0.01% or more. The Cu content is more preferably 0.02% or more, and still more preferably 0.03% or more.

On the other hand, when the Cu content exceeds 0.50%, the steel sheet is embrittled during hot rolling. Therefore, in the base steel sheet of the grain-oriented electrical steel sheet according to the embodiment, the Cu content is preferably 0.50% or less. The Cu content is more preferably 0.30% or less, and still more preferably 0.10% or less.

### Se: 0 to 0.020%

Se (selenium) is an element having an effect of improving magnetic characteristics. When Se is included, the Se content is preferably 0.001% or more such that Se favorably exhibits the effect of improving magnetic characteristics. The Se content is more preferably 0.003% or more, and still more preferably 0.006% or more.

On the other hand, when the Se content exceeds 0.020%, adhesion of the coating is deteriorated. Therefore, the Se content is preferably 0.020% or less. The Se content is more preferably 0.015% or less, and still more preferably 0.010% or less.

### Sb: 0 to 0.50%

Sb (antimony) is an element having an effect of improving magnetic characteristics. When Sb is included, the Sb content is preferably 0.005% or more such that Sb favorably exhibits the effect of improving magnetic characteristics. The Sb content is more preferably 0.01% or more, and still more preferably 0.02% or more.

On the other hand, when the Sb content exceeds 0.50%, adhesion of the coating is significantly deteriorated. Therefore, the Sb content is preferably 0.50% or less. The Sb content is more preferably 0.30% or less, and still more preferably 0.10% or less.

As described above, for example, the chemical composition of the base steel sheet of the grain-oriented electrical steel sheet according to the embodiment contains the above-described elements, with the balance being Fe and impurities.

The chemical composition of the base steel sheet of the grain-oriented electrical steel sheet according to the embodiment can be measured using a known ICP emission spectrometry. Note that, at the time of measurement, in a case where an insulating coating is formed on the surface, the measurement is performed after the insulating coating is peeled off. As a peeling method, it is possible to peel off the insulating coating by immersing the steel sheet in a high-concentration alkaline solution (for example, a 30% sodium hydroxide solution heated to 85° C.) for 20 minutes or more. It is possible to visually determine whether or not they have been peeled off. In a case of a small sample, the insulating coating may be peeled off by surface grinding.

### <Insulating Coating>

In the grain-oriented electrical steel sheet 100 according to the embodiment, the insulating coating 2 is formed on the surface of the base steel sheet 1.

The insulating coating 2 includes the intermediate layer 21 and the tension coating layer 22 in this order from the base steel sheet 1 side.

### (Intermediate Layer)

As described above, in general, a grain-oriented electrical steel sheet has a forsterite-based coating generated in a finishing annealing step and an insulating coating (tension insulating coating) formed thereon. However, in recent years, it has been clarified that the forsterite-based coating hinders movement of a domain wall and adversely affects iron loss, and thus, in order to further improve magnetic characteristics, a grain-oriented electrical steel sheet having no forsterite-based coating has been studied. However, when the forsterite-based coating is not present, it is difficult to ensure sufficient adhesion between a tension coating and the surface of a base steel sheet.

In the grain-oriented electrical steel sheet 100 according to the embodiment, the intermediate layer 21 containing a crystalline metal phosphate is formed between the base steel sheet 1 and the tension coating to improve adhesion between the base steel sheet 1 and the tension coating layer 22 via the intermediate layer 21.

This is because when the intermediate layer 21 contains a crystalline metal phosphate, the tension coating formed thereon (after formed, becomes the tension coating layer 22) also contains a metal phosphate and therefore has high affinity therewith, thereby exhibiting excellent adhesion between the intermediate layer and the tension coating layer. In addition, as described later, when the intermediate layer is formed by immersion in a treatment liquid containing a metal phosphate, the intermediate layer can be formed on the surface of the base steel sheet 1 using a chemical reaction, and adhesion between the intermediate layer 21 and the base steel sheet 1 can also be ensured.

When the intermediate layer 21 does not contain a crystalline metal phosphate, the above effect cannot be obtained. The percentage of the crystalline metal phosphate in the intermediate layer is preferably 80 mass % or more, and may be 100 mass %. As the metal phosphate, at least one of zinc phosphate, manganese phosphate, iron phosphate, and zinc calcium phosphate is preferably used from the viewpoint of adhesion.

The intermediate layer may contain, as the balance of the metal phosphate, an oxide or an element diffused from the base steel sheet, such as Fe or Si.

However, when the crystal of the crystalline metal phosphate becomes coarse in the intermediate layer, the actually manufactured transformer has a reduced space factor, thereby having a reduced magnetic flux density per unit volume and an increased transformer iron loss.

Therefore, in the grain-oriented electrical steel sheet according to the embodiment, the crystalline metal phosphate contained in the intermediate layer has a plate shape, and has an average grain size of 0.5 to 3.0 μm. Here, the plate shape refers to a shape in which one side of the sides in three directions of the crystal is less than ⅕ times longer than the other two sides. On the other hand, the columnar shape refers to a shape in which one side of the sides in three directions of the crystal is 5 or more times longer than the other two sides, and the other two sides are from 0.5 times to less than 2.0 times longer than each other. The particle shape refers to a shape in which the three directions of the crystal are from 0.5 times to less than 2.0 times longer than each other. The needle shape refers to a shape in which one side of the sides in three directions of the crystal is 20 or more times longer than the other two sides, and the other two sides are from 0.5 times to less than 2.0 times longer than each other.

When the crystalline metal phosphate does not have a plate shape, the space factor decreases, or the adhesion becomes poor.

In addition, when the average grain size is less than 0.5 μm, the crystals are sparse, and the adhesion is poor. When the average grain size is more than 3.0 μm, the space factor is poor.

Although the intermediate layer 21 and the tension coating formed thereon are formed at different timings, both the intermediate layer 21 and the tension coating layer 22 exhibit the effect of the insulating coating 2.

The thickness of the intermediate layer is preferably 0.1 to 9.0 μm from the viewpoint of achieving both adhesion and magnetism. When the average thickness of the intermediate layer 21 is less than 0.1 μm, the effect of improving the adhesion between the base steel sheet and the insulating coating via the intermediate layer is sometimes not sufficiently obtained. On the other hand, when the average thickness of the intermediate layer exceeds 9.0 μm, the magnetic characteristics may deteriorate.

As for the crystalline metal phosphate in the intermediate layer, the mass ratio of the metal phosphate and the type of the metal phosphate are determined by measuring the cross section of the intermediate layer along the thickness direction with a scanning electron microscope and an energy dispersive element analyzer. Whether the metal phosphate of the intermediate layer 21 is a crystalline metal phosphate can be determined by X-ray crystallography.

As for the thickness of the intermediate layer, a cross section of a sample is observed with a scanning electron microscope, and the thicknesses at five or more points are measured, whereby an average thickness can be measured. The base steel sheet and the insulating coating can be determined based on the concentration of P (phosphorus) derived from the metal phosphate (the insulating coating may be determined when the P content is 1.0 mass % or more, and the base steel sheet may be determined when the P content is less than 1.0 mass %). In the insulating coating 2, the intermediate layer 21 and the tension coating layer 22 can be determined by whether silicon (Si) derived from silica is detected (the tension coating layer contains silica as described later).

The average grain size of the crystalline metal phosphate can be determined by the following method.

A steel sheet sample is cut into a few mm square, and subjected to ion milling process (CP process) to remove microscopic shape defects such as sagging and cracks. Then the steel sheet is observed with a scanning electron microscope on a cross section along the rolling direction of the steel sheet and on a cross section along the direction perpendicular to the rolling direction of the steel sheet. When the observed metal phosphate includes, as its crystal form, two or more crystals in which one side is ⅕ or less longer than the other sides, it is determined that a plate-shaped crystal is generated. In addition, the average grain size is determined by measuring the long side of five or more crystals among the observed metal phosphate crystals, and averaging the same. The electron microscope observation is performed at a magnification of 1000 at five observation points.

### (Tension Coating Layer)

The grain-oriented electrical steel sheet 100 according to the embodiment, in which a tension coating is formed on the surface of the intermediate layer 21, has the tension coating layer 22 on the surface side of the insulating coating 2.

The tension coating layer 22 is not particularly limited as long as it is used as an insulating coating of a grain-oriented electrical steel sheet, but preferably has a composition mainly containing a metal phosphate from the viewpoint of adhesion to the intermediate layer 21 (adhesion to the base steel sheet 1 through the intermediate layer 21). The tension coating layer 22 is preferably substantially made of a metal phosphate and silica.

The tension coating layer 22 preferably contains a metal phosphate and silica (derived from colloidal silica in the coating liquid) such that the silica content is 20 mass % or more. On the other hand, when the silica content in the tension coating layer 22 is more than 60 mass %, powderization occurs. Therefore, the silica content is preferably 60 mass % or less. The metal phosphate and silica are preferably contained in a total amount of 70 mass % or more. The total of the metal phosphate and silica may be 100 mass %. As the balance other than the metal phosphate and silica, ceramic fine particles such as alumina and silicon nitride may be included. The metal phosphate is preferably aluminum phosphate from the viewpoint of heat resistance.

The thickness of the tension coating layer 22 is not limited, but the average thickness as the insulating coating 2 (intermediate layer 21+tension coating layer 22) is preferably 1.0 to 20.0 μm when the average thickness of the intermediate layer 21 is in the above range. When the average thickness of the insulating coating 2 is less than 1.0 μm, a sufficient coating tension cannot be obtained. In addition, elution of phosphoric acid increases. In this case, this may cause stickiness and corrosion resistance deterioration, and may cause coating peeling. When the thickness of the insulating coating 2 is more than 20.0 μm, the space factor decreases to deteriorate magnetic characteristics, adhesion decreases due to cracking or the like, or corrosion resistance decreases.

In the tension coating layer 22, the mass percentage of the metal phosphate and the type of the metal phosphate can be determined in the cross section along the thickness direction in the same manner as in the intermediate layer.

As described above, the tension coating layer and the intermediate layer can be determined by the difference in the silica content.

The thickness of the tension coating layer 22 can be determined in the same manner as in the intermediate layer 21. The total of the thickness of the tension coating layer 22 and the thickness of the intermediate layer 21 is determined as the thickness of the insulating coating 2.

### Manufacturing Method

According to the manufacturing method satisfying the manufacturing conditions described below, the grain-oriented electrical steel sheet according to the embodiment can be suitably manufactured. Note that, as a matter of course, the grain-oriented electrical steel sheet according to the embodiment is not particularly limited in its manufacturing method. That is, a grain-oriented electrical steel sheet having the above-described configurations is regarded as the grain-oriented electrical steel sheet according to the embodiment, regardless of the manufacturing conditions thereof.

The grain-oriented electrical steel sheet according to the embodiment can be manufactured by a manufacturing method including the following steps:
(I) a hot rolling step of hot rolling a steel piece having a predetermined chemical composition to obtain a hot-band;
(II) a hot-band annealing step of annealing the hot-band;
(III) a cold rolling step of cold rolling the hot-band after the hot-band annealing step to obtain a steel sheet (cold-band);
(IV) a decarburization annealing step of decarburization annealing the steel sheet after the cold rolling step;
(V) a finishing annealing step of applying an annealing separator containing Al₂O₃ in an amount of 10 to 100 mass % onto a steel sheet, drying the steel sheet, and then finishing annealing the steel sheet;
(VII) an annealing separator removing step of removing an excess of the annealing separator from the steel sheet after the finishing annealing step;
(VIII) a light pickling step of pickling the steel sheet after the annealing separator removing step with 0.1 to 10.0 mass % of one inorganic acid selected from sulfuric acid, chloric acid, nitric acid, and phosphoric acid at a liquid temperature of 20 to 90° C. for 1 to 20 seconds;
(IX) an intermediate layer forming step of washing the steel sheet after the light pickling step with water, and then energizing the steel sheet for 3 to 30 seconds at a current density of 1.0 to 50 A/dm² in a mixed treatment liquid having a metal ion concentration of 10 to 50 g/l, a phosphate ion concentration of 10 to 100 g/l, and a nitrate ion concentration of 20 to 80 g/l at a liquid temperature of 30 to 90° C.;
(X) a drying step of pulling up the steel sheet after the intermediate layer forming step from the mixed treatment liquid, removing an excess of the mixed treatment liquid, and then drying the steel sheet; and
(XI) a tension coating layer forming step of applying a coating liquid containing a metal phosphate and colloidal silica, the metal phosphate and the colloidal silica contained in a total concentration of 10 to 40 mass %, to the steel sheet after the drying step, drying the steel sheet, and then heating and holding the steel sheet at a sheet temperature of 700 to 950° C. for 10 to 60 seconds.

In addition, the manufacturing method of the grain-oriented electrical steel sheet according to the embodiment may further include one or both of
(XII) a nitriding treatment step of subjecting the steel sheet to a nitriding treatment between the decarburization annealing step and the finishing annealing step, and
(XIII) a magnetic domain refinement step of performing magnetic domain control of the steel sheet after the tension coating layer forming step.

Among these steps, (V) finishing annealing step to (XI) tension coating layer forming step (also collectively referred to as method for forming insulating coating), which are mainly related to formation of the insulating coating, are characteristic in the manufacture of the grain-oriented electrical steel sheet according to the embodiment, and known conditions may be adopted for other steps or conditions not described.

Hereinafter, these steps will be described.

### [Hot Rolling Step]

In the hot rolling step, a steel piece having a predetermined chemical composition, such as a slab, is heated and then hot rolled to obtain a hot-band. The heating temperature of the steel piece is preferably in a range of 1100 to 1450° C. The heating temperature is more preferably 1300 to 1400° C.

The chemical composition of the steel piece is changed according to the chemical composition of the grain-oriented electrical steel sheet to be finally obtained, but, for example, the chemical composition includes, in terms of mass %, 0.01 to 0.20% of C, 2.50 to 4.00% of Si, 0.01 to 0.040% of sol. Al, 0.01 to 0.50% of Mn, 0.020% or less of N, 0.005 to 0.040% of S, 0 to 0.50% of Cu, 0 to 0.50% of Sn, 0 to 0.020% of Se, 0 to 0.50% of Sb, and a balance including Fe and impurities.

The hot rolling conditions are not particularly limited, and may be appropriately set based on required characteristics. The sheet thickness of the hot-band is preferably, for example, in a range of 2.0 to 3.0 mm.

### [Hot-Band Annealing Step]

The hot-band annealing step is a step of annealing the hot-band manufactured through the hot rolling step. By performing such an annealing treatment, recrystallization occurs in the metallographic structure, and favorable magnetic characteristics can be preferably achieved.

When hot-band annealing is performed, the hot-band manufactured through the hot rolling step is annealed according to a known method. The means for heating the hot-band at the time of annealing is not particularly limited, and a known heating method can be adopted. The annealing conditions are not particularly limited. For example, the hot-band can be annealed in a temperature range of 900 to 1200° C. for 10 seconds to 5 minutes.

### [Cold Rolling Step]

In the cold rolling step, the hot-band after the hot-band annealing step is subjected to cold rolling to obtain a steel sheet (cold-band). The cold rolling may be performed one time (continuously performed without intervening intermediate annealing(s)). Alternatively, before the final pass in the cold rolling step, intermediate annealing may be performed at least one time or two or more times by interrupting cold rolling, that is, cold rolling may be performed several times with intervening intermediate annealing(s).

When the intermediate annealing is performed, it is preferable to hold the hot-band at a temperature of 1000 to 1200° C. for 5 to 180 seconds. The annealing atmosphere is not particularly limited. The number of times of intermediate annealing is preferably 3 or less in consideration of manufacturing cost.

In addition, before the cold rolling step, the surface of the hot-band may be subjected to pickling.

In the cold rolling step according to the embodiment, the hot-band after the hot-band annealing step is cold rolled according to a known method to form a steel sheet. For example, the final rolling reduction can be in a range of 80 to 95%. When the final rolling reduction is 80% or more, a Goss nucleus in which the {110}<001> orientation has a high development degree in a rolling direction can be obtained, which is preferable. On the other hand, when the final rolling reduction exceeds 95%, there is a high possibility that secondary recrystallization is unstable in the subsequent finishing annealing step, which is not preferable.

The final rolling reduction is a cumulative rolling reduction of cold rolling, and when intermediate annealing is performed, the final rolling reduction is a cumulative rolling reduction of cold rolling after the final intermediate annealing.

### [Decarburization Annealing Step]

In the decarburization annealing step, the obtained steel sheet is subjected to decarburization annealing. In the decarburization annealing, decarburization annealing conditions are not limited as long as the steel sheet can be primarily recrystallized and C, which adversely affects the magnetic characteristics, can be removed from the steel sheet. For example, the steel sheet is held at an annealing temperature of 800 to 900° C. for 10 to 600 seconds with a degree of oxidation (PH₂O/PH₂) of 0.3 to 0.6 in an annealing atmosphere (furnace atmosphere).

### [Nitriding Treatment Step]

A nitriding treatment may be performed between the decarburization annealing step and the finishing annealing step described later.

In the nitriding treatment step, for example, the steel sheet after the decarburization annealing step is maintained at about 700 to 850° C. in a nitriding treatment atmosphere (atmosphere containing a gas having nitriding ability, such as hydrogen, nitrogen, or ammonia) to perform the nitriding treatment. When AlN is utilized as an inhibitor, the N content of the steel sheet after the nitriding treatment step is preferably 40 ppm or more by the nitriding treatment. On the other hand, when the N content of the steel sheet after the nitriding treatment step exceeds 1000 ppm, AlN is excessively present in the steel sheet even after completion of secondary recrystallization in the finishing annealing. Such AlN causes iron loss deterioration. Therefore, the N content of the steel sheet after the nitriding treatment step is preferably 1000 ppm or less.

### [Finishing Annealing Step]

In the finishing annealing step, an annealing separator containing 10 to 100 mass % of Al₂O₃ is applied to the steel sheet that is after the decarburization annealing step or has been further subjected to the nitriding treatment (after the nitriding treatment step), and dried, and then finishing annealing is performed.

In a conventional manufacturing method of a grain-oriented electrical steel sheet, a forsterite-based coating is formed on the surface of a steel sheet (cold-band) by applying an annealing separator mainly containing MgO and performing finishing annealing.

On the other hand, in the manufacturing method of the grain-oriented electrical steel sheet according to the embodiment, an annealing separator containing Al₂O₃ is used to form substantially no forsterite-based coating.

On the other hand, the percentage of Al₂O₃ may be 100 mass %. However, in the manufacturing method of the grain-oriented electrical steel sheet according to the embodiment, the annealing separator preferably contains MgO from the viewpoint of preventing the sheet surface from being baked with Al₂O₃. MgO may be 0%, but the percentage of MgO is preferably 5 mass % or more to obtain the above effect. When MgO is contained, the percentage of MgO is 90 mass % or less in order to ensure 10 mass % or more of Al₂O₃. The percentage of MgO is preferably 50 mass % or less. The total of Al₂O₃ and MgO may be more than 50 mass % in terms of solid content with respect to the annealing separator.

In addition, in the manufacturing method of the grain-oriented electrical steel sheet according to the embodiment, the annealing separator may further contain a chloride. When the annealing separator contains a chloride, an effect that a forsterite-based coating is more hardly formed can be obtained. The amount of the chloride is not particularly limited, and may be 0%, but is preferably 0.5 to 10 mass % when the above effect is to be obtained. As the chloride, for example, bismuth chloride, calcium chloride, cobalt chloride, iron chloride, and nickel chloride are effective.

Finishing annealing conditions are not limited, but for example, a condition of holding the steel sheet at a temperature of 1150 to 1250° C. for 10 to 60 hours can be adopted.

### [Annealing Separator Removing Step]

In the annealing separator removing step, an excess of the annealing separator is removed from the steel sheet after the finishing annealing step. For example, the excess of the annealing separator can be removed by performing water washing.

### [Light Pickling Step]

In the light pickling step, the steel sheet after the annealing separator removing step is subjected to pickling with 0.1 to 10.0 mass % of one inorganic acid selected from sulfuric acid, chloric acid, nitric acid, and phosphoric acid at a liquid temperature of 20 to 90° C. for 1 to 20 seconds. Thereby, the effect of densifying the crystalline phosphate is obtained.

When the light pickling conditions are not appropriate, the adhesion of the tension coating layer becomes poor.

### [Intermediate Layer Forming Step]

### [Drying Step]

In the intermediate layer forming step, the steel sheet after the light pickling step is washed with water, and then immersed in a treatment liquid. In the state where the steel sheet is immersed, the treatment liquid is energized, thereby forming an intermediate layer. In the drying step, the steel sheet after the intermediate layer forming step is pulled up from the treatment liquid, an excess of the treatment liquid is removed, and then the steel sheet is dried. Thereby, the intermediate layer is formed on the surface of the base steel sheet.

Here, the treatment liquid is a mixed treatment liquid having a metal ion concentration of 10 to 50 g/l, a phosphate ion concentration of 10 to 100 g/l, and a nitrate ion concentration of 20 to 80 g/l.

When the mixed treatment liquid has a metal ion concentration of less than 10 g/l, the generation of the crystalline metal phosphate is suppressed, and the crystal has a particle shape and the adhesion is poor. On the other hand, when the metal ion concentration is more than 50 g/l, the generation of the crystalline metal phosphate easily varies, and coarse crystals are developed so that the space factor is reduced, and the intermediate layer is unevenly formed. In addition, when the mixed treatment liquid has a phosphate ion concentration of less than 10 g/l, the crystalline metal phosphate takes time to precipitate, and coarse crystals are developed so that the space factor becomes poor. On the other hand, when the phosphate ion concentration is more than 100 g/l, the generation of the crystalline metal phosphate easily varies, and coarse crystals are developed and the surface of the steel sheet is etched, so that the space factor is reduced, or the corrosion resistance and the coating tension are reduced. In addition, when the mixed treatment liquid has a nitrate ion concentration of less than 20 g/l, the generation of hydrogen gas cannot be suppressed and current becomes difficult to flow uniformly: in the part through which current flows, the intermediate layer is partially formed to be excessively thick, thereby reducing adhesion; and in the part through which no current flows, the intermediate layer is thin, thereby reducing coating tension. On the other hand, when the nitrate ion concentration is more than 80 g/l, the phosphate ion concentration decreases as a result, so that the crystalline metal phosphate takes time to precipitate, and coarse needle-shaped crystals are developed so that the space factor becomes poor.

During immersion, the mixed treatment liquid has a liquid temperature of 30 to 90° C. When the mixed treatment liquid has a liquid temperature of less than 30° C., the crystalline metal phosphate takes too much time to precipitate, which is not economical. On the other hand, when the liquid temperature is higher than 90° C., the mixed treatment liquid becomes unstable, and the intermediate layer is unevenly formed.

During energization, the current density is 1.0 to 50 A/dm². When the current density is less than 1.0 A/dm², the crystalline metal phosphate takes too much time to precipitate, which is not economical.

On the other hand, when the current density is more than 50 A/dm², current becomes difficult to flow uniformly through the sample, causing an unevenly formed intermediate layer, called “transparent”. When the energization time is short, it is easy that the intermediate layer takes time to form, or sparsely adheres. On the other hand, when the energization time is long, the intermediate layer is excessively generated in some parts, and an uneven state called “adhesion unevenness” or “transparent” is easily generated. Therefore, the energization time is preferably 3 to 30 seconds.

When the drying temperature is high, there is a possibility that voids generate, leading to poor adhesion. Therefore, the drying temperature is preferably 300° C. or lower, and more preferably 200° C. or lower. The drying temperature is preferably 100° C. or higher.

### [Tension Coating Layer Forming Step]

In the tension coating layer forming step, a coating liquid containing a metal phosphate and colloidal silica, the metal phosphate and the colloidal silica contained in a total concentration of 10 to 40 mass %, is applied to the steel sheet after the drying step, the steel sheet is dried, and then the steel sheet is heated and held at a sheet temperature of 700 to 950° C. for 10 to 60 seconds, thereby forming a tension coating layer on the surface of the intermediate layer.

When the sheet temperature is held at lower than 700° C., the tension is low and magnetic characteristics are poor. Therefore, the sheet temperature is preferably 700° C. or higher. On the other hand, when the sheet temperature is higher than 950° C., the rigidity of the steel sheet decreases and the steel sheet is easily deformed. In this case, the steel sheet may be distorted due to transfer or the like, resulting in poor magnetic characteristics. Therefore, the sheet temperature is preferably 950° C. or lower.

When the holding time is less than 10 seconds, elution resistance is poor. Therefore, the holding time is 10 seconds or more. On the other hand, when the holding time is more than 60 seconds, adhesion of the tension coating layer is poor. Therefore, the holding time is preferably 60 seconds or less.

The coating liquid (insulating coating solution) contains the metal phosphate and the colloidal silica in a total amount of 10 to 40 mass %.

When the concentration is less than 10 mass %, the applied coating liquid easily flows, which may cause uneven application amount. In addition, when the concentration is more than 40 mass %, the viscosity becomes too high, which may cause a pattern or coating unevenness.

As the metal phosphate, for example, one or a mixture of two or more selected from aluminum phosphate, zinc phosphate, magnesium phosphate, nickel phosphate, copper phosphate, lithium phosphate, and cobalt phosphate can be used. From the viewpoint of the stability of the coating liquid, aluminum phosphate is preferable.

The coating liquid may contain vanadium, tungsten, molybdenum, zirconium, and the like as additional elements. When these elements are contained, they can be added to the coating liquid, for example, as an oxygen acid.

As the colloidal silica, S-type or C-type can be used. The S-type colloidal silica is alkaline in silica solution. The C-type has its silica particle surface treated with aluminum, and is alkaline to neutral in silica solution. The S-type colloidal silica is widely and generally used, and is relatively inexpensive in price, but it is necessary to be careful because the S-type colloidal silica may aggregate and precipitate when being mixed with an acidic metal phosphate solution. The C-type colloidal silica is stable even when being mixed with a metal phosphate solution, and there is no possibility of precipitation, but the C-type colloidal silica is relatively expensive because the number of treatment steps is large. It is preferable to select and use them according to the stability of a coating liquid to be prepared.

### [Magnetic Domain Refinement Step]

The manufacturing method of the grain-oriented electrical steel sheet according to the embodiment may further include a magnetic domain refinement step of performing magnetic domain refinement on the steel sheet after the tension coating layer forming step.

By performing the magnetic domain refinement treatment, the iron loss of the grain-oriented electrical steel sheet can be further reduced.

The method of the magnetic domain refinement treatment include: a method for narrowing the width of a 180° magnetic domain (performing refinement of a 180° magnetic domain) by forming linear or dotted groove parts extending in a direction intersecting a rolling direction at predetermined intervals in the rolling direction; and a method for narrowing the width of a 180° magnetic domain (performing refinement of a 180° magnetic domain) by forming linear or dotted stress-strain parts or groove parts extending in a direction intersecting a rolling direction at predetermined intervals in the rolling direction.

In a case where a stress-strain part is formed, laser beam irradiation, electron beam irradiation, and the like can be applied. In a case where a groove part is formed, a mechanical groove forming method using a gear or the like, a chemical groove forming method of forming a groove by electrolytic etching, a thermal groove forming method by laser irradiation, and the like can be applied.

In a case where the insulating coating is damaged due to formation of a stress-strain part or a groove part and characteristics such as insulation properties are deteriorated, the insulating coating may be formed again to repair the damage.

### EXAMPLES

A slab including, in terms of mass %, 0.08% of C, 3.31% of Si, 0.028% of sol. Al, 0.008% of N, 0.07% of Mn, less than 0.0005% of S, and a balance including Fe and impurities was cast.

This slab was heated to 1350° C. and then hot rolled to form a hot-band having a sheet thickness of 2.2 mm. The hot-band was annealed under the conditions of holding at 1100° C. for 10 seconds.

Thereafter, the hot-band was cold rolled to obtain a cold-band having a sheet thickness of 0.22 mm. The cold-band was decarburization annealed by holding at 830° C. for 90 seconds.

After decarburization annealing, an annealing separator containing 45 mass % of MgO, 50 mass % of Al₂O₃, and 5 mass % of BiCl₃ as a bismuth chloride was applied and dried, and then finishing annealing was performed at 1200° C. for 20 hours.

After finishing annealing, the steel sheet was washed with water to remove an excess of the annealing separator. As a result, no forsterite-based coating was formed on the surface of the steel sheet.

The steel sheet was subjected to light pickling under the conditions of Tables 2A and 2B.

After light pickling, an intermediate layer was formed from a treatment liquid in which a phosphate and an additive are mixed (mixed treatment liquid) using electrolytic treatment under the conditions shown in Table 1. The drying temperature was 200° C. The obtained intermediate layer was as shown in Tables 2A and 2B. The percentage of the crystalline metal phosphate in the intermediate layer was 80 mass % or more.

Thereafter, an insulating coating solution made of a metal phosphate and colloidal silica shown in Tables 2A and 2B was applied, and dried at 850° C. for 30 seconds, to form a tension insulating coating on the surface of the steel sheet.

The thickness of the insulating coating (intermediate layer and tension coating layer) was as shown in Tables 2A and 2B. The tension coating layer was substantially made of a metal phosphate and silica. The shape, average grain size, and thickness were measured as described above.

TABLE 1

| | | | | | | Electrolytic treatment | | |
|---|---|---|---|---|---|---|---|---|
| | | | | | | conditions | | |
| | Treatment liquid | | | | | Treatment | | |
| | Phosphate | Ion concentration (g/l) | | | | liquid | Current | Energization |
| Intermediate | treatment | Metal | Phosphate | Nitrate | | temperature | density | time |
| layer No. | liquid | ion | ion | ion | Others | (° C.) | (A/dm²) | (sec) |
| 1 | Manganese | 30 | 40 | 70 | — | 40 | 16 | 10 |
| | phosphate | | | | | | | |
| 2 | Manganese | 30 | 40 | 60 | — | 30 | 20 | 5 |
| | phosphate | | | | | | | |
| 3 | Zinc phosphate | 45 | 70 | 25 | — | 85 | 1.2 | 10 |
| 4 | Zinc phosphate | 40 | 65 | 20 | — | 85 | 6 | 20 |
| 5 | Zinc calcium | 15 | 30 | 30 | — | 80 | 20 | 12 |
| | phosphate | | | | | | | |
| 6 | Manganese | 10 | 25 | 20 | — | 40 | 45 | 4 |
| | phosphate | | | | | | | |
| 7 | Manganese | 20 | 40 | 60 | — | 60 | 4 | 4 |
| | phosphate | | | | | | | |
| 8 | Zinc phosphate | 15 | 18 | 25 | — | 50 | 16 | 10 |
| 9 | Manganese | 10 | 5 | 20 | — | 85 | 20 | 20 |
| | phosphate | | | | | | | |
| 10 | Manganese | 30 | 160 | 60 | — | 40 | 20 | 10 |
| | phosphate | | | | | | | |
| 11 | Zinc phosphate | 0.2 | 20 | 20 | — | 40 | 12 | 10 |
| 12 | Zinc phosphate | 120 | 40 | 60 | — | 85 | 20 | 20 |
| 13 | Manganese | 10 | 30 | 15 | — | 85 | 30 | 10 |
| | phosphate | | | | | | | |
| 14 | Manganese | 30 | 40 | 100 | — | 50 | 50 | 5 |
| | phosphate | | | | | | | |
| 15 | Manganese | 30 | 40 | 20 | — | 60 | 0.5 | 30 |
| | phosphate | | | | | | | |
| 16 | Manganese | 30 | 40 | 20 | — | 50 | 150 | 5 |
| | phosphate | | | | | | | |
| 17 | Zinc phosphate | 30 | 40 | — | — | 40 | 16 | 10 |
| 18 | Manganese | 30 | 40 | — | Chloric | 40 | 20 | 10 |
| | phosphate | | | | acid: 10 | | | |

TABLE 2A

| | | | | | | Intermediate layer | | | Tension coating layer | |
|---|---|---|---|---|---|---|---|---|---|---|
| | | | | | | Crystalline metal | | | forming step | |
| | | | | | Intermediate | phosphate | | | Coating liquid | |
| | Light pickling step | | | | layer | | Average | | Phosphate | Metal |
| | | | Liquid | | forming step | | grain | | (100 parts | element |
| | Type | Concentration | temperature | Time | Intermediate | | size | Thickness | by mass) | molar |
| No. | of acid | Mass % | ° C. | sec | layer No. | Form | (μm) | (μm) | Type | ratio |
| 1 | H₂SO₄ | 2.0 | 80 | 10 | 1 | Plate | 1.6 | 3.2 | Aluminum | — |
| | | | | | | shape | | | phosphate | |
| 2 | H₂SO₄ | 0.5 | 80 | 10 | 2 | Plate | 2.1 | 6.4 | Aluminum/Copper | 0.17 |
| | | | | | | shape | | | phosphate | |
| 3 | H₂SO₄ | 1.0 | 85 | 5 | 3 | Plate | 0.8 | 1.8 | Aluminum/Lithium | 0.17 |
| | | | | | | shape | | | phosphate | |
| 4 | H₃PO₄ | 4.5 | 65 | 15 | 4 | Plate | 0.5 | 1.2 | Aluminum/Strontium | 0.17 |
| | | | | | | shape | | | phosphate | |
| 5 | H₃PO₄ | 3.0 | 70 | 15 | 5 | Plate | 2.4 | 5.4 | Aluminum/Molybdenum | 0.17 |
| | | | | | | shape | | | phosphate | |
| 6 | H₃PO₄ | 2.5 | 65 | 20 | 6 | Plate | 2.8 | 7.4 | Aluminum/Vanadium | 0.14 |
| | | | | | | shape | | | phosphate | |
| 7 | HNO₃ | 0.5 | 40 | 10 | 7 | Plate | 1.7 | 2.6 | Aluminum/Tungsten | 0.14 |
| | | | | | | shape | | | phosphate | |
| 8 | HNO₃ | 0.5 | 40 | 10 | 8 | Plate | 1.3 | 4.4 | Aluminum/Zirconium | 0.14 |
| | | | | | | shape | | | phosphate | |
| 9 | HClO₃ | 0.5 | 30 | 15 | 1 | Plate | 0.6 | 1.1 | Aluminum/Copper | 0.17 |
| | | | | | | shape | | | phosphate | |
| 10 | H₂SO₄ | 1.5 | 80 | 20 | 9 | Particle | 3.2 | 9.2 | Aluminum/Lithium | 0.17 |
| | | | | | | shape | | | phosphate | |
| 11 | H₂SO₄ | 2.5 | 80 | 15 | 10 | Particle | 5.2 | 7.6 | Aluminum/Lithium | 0.17 |
| | | | | | | shape | | | phosphate | |

| | Tension coating layer | | | | | |
|---|---|---|---|---|---|---|
| | forming step | | | | | |
| | Coating liquid | | | | | |
| | | | Total | | | |
| | | | concentration | Tension | | |
| | | | of metal | coating | | |
| | | | phosphate and | layer | Insulating | |
| | Colloidal silica | | colloidal | Silica | coating | |
| | | Parts | silica | content | Thickness | |
| No. | Type | by mass | (mass %) | (mass %) | (μm) | Note |
| 1 | S- | 120 | 34 | 55 | 6.7 | Invention |
| | type | | | | | Example |
| 2 | S- | 90 | 35 | 47 | 9.7 | Invention |
| | type | | | | | Example |
| 3 | S- | 80 | 35 | 44 | 5.3 | Invention |
| | type | | | | | Example |
| 4 | C- | 100 | 27 | 50 | 4.7 | Invention |
| | type | | | | | Example |
| 5 | C- | 100 | 27 | 50 | 8.9 | Invention |
| | type | | | | | Example |
| 6 | C- | 90 | 27 | 47 | 9.8 | Invention |
| | type | | | | | Example |
| 7 | C- | 90 | 27 | 47 | 6.1 | Invention |
| | type | | | | | Example |
| 8 | C- | 70 | 28 | 41 | 7.9 | Invention |
| | type | | | | | Example |
| 9 | S- | 90 | 35 | 47 | 6.7 | Invention |
| | type | | | | | Example |
| 10 | S- | 80 | 35 | 44 | 12.9 | Comparative |
| | type | | | | | Example |
| 11 | S- | 80 | 35 | 44 | 11.3 | Comparative |
| | type | | | | | Example |

TABLE 2B

| | | | | | | Intermediate layer | | | Tension coating layer | |
|---|---|---|---|---|---|---|---|---|---|---|
| | | | | | | Crystalline metal | | | forming step | |
| | | | | | Intermediate | phosphate | | | Coating liquid | |
| | Light pickling step | | | | layer | | Average | | Phosphate | Metal |
| | | | Liquid | | forming step | | grain | | (100 parts | element |
| | Type | Concentration | temperature | Time | Intermediate | | size | Thickness | by mass) | molar |
| No. | of acid | Mass % | ° C. | sec | layer No. | Form | (μm) | (μm) | Type | ratio |
| 12 | H₂SO₄ | 2.5 | 75 | 15 | 11 | Particle | 0.8 | 2.1 | Aluminum/Lithium | 0.17 |
| | | | | | | shape | | | phosphate | |
| 13 | H₂SO₄ | 2.0 | 65 | 20 | 12 | Particle | 4.6 | 8.7 | Aluminum/Lithium | 0.17 |
| | | | | | | shape | | | phosphate | |
| 14 | H₃PO₄ | 3.5 | 60 | 20 | 13 | Columnar | 2.6 | 9.7 | Aluminum/Lithium | 0.17 |
| | | | | | | shape | | | phosphate | |
| 15 | H₃PO₄ | 4.5 | 60 | 15 | 14 | Needle | 4.1 | 6.4 | Aluminum/Lithium | 0.17 |
| | | | | | | shape | | | phosphate | |
| 16 | H₃PO₄ | 4.0 | 60 | 20 | 15 | Columnar | 1.2 | 0.6 | Aluminum/Lithium | 0.17 |
| | | | | | | shape | | | phosphate | |
| 17 | H₃PO₄ | 3.5 | 60 | 20 | 16 | Needle | 3.8 | 10.5 | Aluminum/Lithium | 0.17 |
| | | | | | | shape | | | phosphate | |
| 18 | HNO₃ | 1.0 | 35 | 20 | 17 | Columnar | 0.2 | 1.2 | Aluminum/Copper | 0.17 |
| | | | | | | shape | | | phosphate | |
| 19 | HNO₃ | 1.0 | 35 | 20 | 18 | Particle | 3.1 | 5.4 | Aluminum/Copper | 0.17 |
| | | | | | | shape | | | phosphate | |
| 20 | H₂SO₄ | 13.0 | 80 | 20 | 2 | Particle | 5.6 | 3.4 | Aluminum/Copper | 0.17 |
| | | | | | | shape | | | phosphate | |
| 21 | H₃PO₄ | 6.0 | 80 | 60 | 2 | Particle | 3.7 | 4.4 | Aluminum/Copper | 0.17 |
| | | | | | | shape | | | phosphate | |
| 22 | HCl | 1.0 | 35 | 20 | 2 | Particle | 5.3 | 3.6 | Aluminum/Copper | 0.17 |
| | | | | | | shape | | | phosphate | |

| | Tension coating layer | | | | | |
|---|---|---|---|---|---|---|
| | forming step | | | | | |
| | Coating liquid | | | | | |
| | | | Total | | | |
| | | | concentration | Tension | | |
| | | | of metal | coating | | |
| | Colloidal | | phosphate and | layer | Insulating | |
| | silica | | colloidal | Silica | coating | |
| | | Parts | silica | content | Thickness | |
| No. | Type | by mass | (mass %) | (mass %) | (μm) | Note |
| 12 | S- | 80 | 35 | 44 | 5.8 | Comparative |
| | type | | | | | Example |
| 13 | S- | 80 | 35 | 44 | 12.4 | Comparative |
| | type | | | | | Example |
| 14 | S- | 80 | 35 | 44 | 13.4 | Comparative |
| | type | | | | | Example |
| 15 | S- | 80 | 35 | 44 | 10.1 | Comparative |
| | type | | | | | Example |
| 16 | S- | 80 | 35 | 44 | 4.3 | Comparative |
| | type | | | | | Example |
| 17 | S- | 80 | 35 | 44 | 14.2 | Comparative |
| | type | | | | | Example |
| 18 | S- | 80 | 35 | 44 | 4.5 | Comparative |
| | type | | | | | Example |
| 19 | S- | 80 | 35 | 44 | 7.5 | Comparative |
| | type | | | | | Example |
| 20 | S- | 80 | 35 | 47 | 6.7 | Comparative |
| | type | | | | | Example |
| 21 | S- | 80 | 35 | 47 | 7.7 | Comparative |
| | type | | | | | Example |
| 22 | S- | 80 | 35 | 47 | 6.9 | Comparative |
| | type | | | | | Example |

The obtained steel sheet (grain-oriented electrical steel sheet) was irradiated with a laser beam under the conditions that UA (irradiation energy density) was 2.0 J and the irradiation interval was 5.0 mm pitch, thereby performing magnetic domain refinement. After magnetic domain refinement, the iron loss W17/50 of the steel sheet (iron loss at 50 Hz under 1.7 T) was measured by the Single Sheet Tester: SST in accordance with JIS C2556 (2015). When the iron loss W17/50 was 0.65 W/kg or less, it was determined that good magnetic characteristics were secured.

In addition, the space factor was measured in the following manner.

### [Space Factor]

The space factor was measured by a method in accordance with JIS C 2550-5 (2020). The test piece had a width of 30 mm and a length of 320 mm, and 30 pieces were used. The samples were measured for the total mass, and then pressurized at 1 MPa, where the space between the upper and lower cover plates sandwiching the laminate was measured to calculate space factor.

When the space factor was 96.0% or more, it was determined that a high space factor was secured.

In addition, the coating adhesion, coating tension, corrosion resistance, elution resistance, and space factor of the steel sheet after magnetic domain refinement were evaluated by the following methods. Table 3 shows the results.

### [Coating Adhesion]

For coating adhesion, a sample having a width of 30 mm and a length of 300 mm was collected from the steel sheet, and the sample was subjected to stress relief annealing at 800° C. for 2 hours in a nitrogen stream. Thereafter, the sample was subjected to a bending and adhering test in which the sample was wound and unwound around a 10 mmφ cylinder, and then the coating was evaluated for peeling degree (area fraction).

Evaluation criteria were as follows, and when a sample was evaluated as L or ∘, the sample was determined to have excellent coating adhesion.
⊙: Peeling area fraction: 0 to 0.5%
∘: Peeling area fraction: more than 0.5% and 5.0% or less
Δ: Peeling area fraction: more than 5.0% and 20% or less
x: Peeling area fraction: more than 20% and 50% or less
XX: Peeling area fraction: more than 50%

### [Coating Tension]

The coating tension was calculated by back calculation from the curved state when one surface of the insulating coating was peeled off. When the obtained coating tension was 4.0 MPa or more, it was determined that the coating tension was sufficient.

### [Corrosion Resistance]

For corrosion resistance, a 5% NaCl aqueous solution was naturally dropped to the sample for 7 hours in an atmosphere of 35° C. in accordance with JIS: Methods of salt spray testing (JIS Z2371:2015).

Thereafter, a rusting area was evaluated at 10 points. Here, the evaluation criteria are as follows. When the score was 5 or more, it was determined that corrosion resistance was excellent.
10: No rust was generated.
9: Rust was generated in an extremely small amount (area fraction was 0.10% or less).
8: Rust was generated in an area fraction of more than 0.10% and 0.25% or less.
7: Rust was generated in an area fraction of more than 0.25% and 0.50% or less.
6: Rust was generated in an area fraction of more than 0.50% and 1.0% or less.
5: Rust was generated in an area fraction of more than 1.0% and 2.5% or less.
4: Rust was generated in an area fraction of more than 2.5% and 5.0% or less.
3: Rust was generated in an area fraction of more than 5.0% and 10% or less.
2: Rust was generated in an area fraction of more than 10% and 25% or less.
1: Rust was generated in an area fraction of more than 25% and 50% or less.

### [Elution Resistance]

The elution resistance was evaluated by whether the elution of phosphoric acid from the sample could be suppressed.

The method for measuring the elution amount was as follows: the sample was boiled in boiled pure water for 10 minutes, the amount of phosphoric acid eluted in the pure water was measured, and the amount of phosphoric acid was divided by the area of the insulating coating of the boiled grain-oriented electrical steel sheet. The amount of phosphoric acid eluted in pure water was measured and calculated as follows: the pure water to which phosphoric acid was eluted (solution) was cooled, and the cooled solution was diluted with pure water to prepare a sample, and the sample was measured for the phosphoric acid concentration with ICP-AES.

When the elution amount was less than 40 mg/m², it was determined that the elution resistance was excellent.

TABLE 3

| | | Coating | | Elution | Space | Iron loss | |
|---|---|---|---|---|---|---|---|
| | Coating | tension | Corrosion | resistance | factor | (W17/50) | |
| No. | adhesion | MPa | resistance | mg/m² | (%) | W/kg | Note |
| 1 | ⊙ | 7.6 | 8 | 22 | 97.4 | 0.62 | Invention |
| | | | | | | | Example |
| 2 | ⊙ | 8.5 | 7 | 28 | 97.1 | 0.61 | Invention |
| | | | | | | | Example |
| 3 | ⊙ | 8.9 | 7 | 31 | 97.4 | 0.60 | Invention |
| | | | | | | | Example |
| 4 | ◯ | 9.6 | 8 | 20 | 97.8 | 0.60 | Invention |
| | | | | | | | Example |
| 5 | ⊙ | 9.4 | 9 | 13 | 96.6 | 0.58 | Invention |
| | | | | | | | Example |
| 6 | ◯ | 6.8 | 7 | 35 | 96.4 | 0.61 | Invention |
| | | | | | | | Example |
| 7 | ◯ | 6.4 | 8 | 28 | 97.0 | 0.63 | Invention |
| | | | | | | | Example |
| 8 | ⊙ | 10.1 | 6 | 31 | 96.7 | 0.57 | Invention |
| | | | | | | | Example |
| 9 | ◯ | 7.1 | 6 | 34 | 96.8 | 0.62 | Invention |
| | | | | | | | Example |
| 10 | ◯ | 8.6 | 9 | 11 | 95.2 | 0.67 | Comparative |
| | | | | | | | Example |
| 11 | ◯ | 3.2 | 3 | 47 | 94.6 | 0.73 | Comparative |
| | | | | | | | Example |
| 12 | X | 7.7 | 7 | 21 | 97.1 | 0.68 | Comparative |
| | | | | | | | Example |
| 13 | ◯ | 6.8 | 7 | 37 | 94.0 | 0.69 | Comparative |
| | | | | | | | Example |
| 14 | X | 3.9 | 5 | 41 | 94.7 | 0.71 | Comparative |
| | | | | | | | Example |
| 15 | ◯ | 9.8 | 8 | 12 | 94.8 | 0.66 | Comparative |
| | | | | | | | Example |
| 16 | Δ | 4.6 | 4 | 24 | 97.4 | 0.72 | Comparative |
| | | | | | | | Example |
| 17 | X | 9.8 | 6 | 48 | 93.3 | 0.69 | Comparative |
| | | | | | | | Example |
| 18 | Δ | 2.3 | 4 | 23 | 97.7 | 0.74 | Comparative |
| | | | | | | | Example |
| 19 | ◯ | 6.5 | 7 | 41 | 95.8 | 0.72 | Comparative |
| | | | | | | | Example |
| 20 | Δ | 4.1 | 7 | 42 | 96.2 | 0.71 | Comparative |
| | | | | | | | Example |
| 21 | Δ | 4.4 | 8 | 52 | 95.9 | 0.73 | Comparative |
| | | | | | | | Example |
| 22 | X | 3.7 | 4 | 29 | 96.2 | 0.77 | Comparative |
| | | | | | | | Example |

As can be seen from Tables 1 to 3, the Invention Examples are extremely excellent in the main coating properties such as adhesion, and are improved in iron loss and space factor.

On the other hand, in Comparative Examples, the method for forming an insulating coating was out of the preferable conditions. Therefore, the intermediate layer did not contain a predetermined crystalline metal phosphate, and at least one of coating adhesion, coating tension, corrosion resistance, elution resistance, and space factor was poor.

### REFERENCE SIGNS LIST

100 Grain-oriented electrical steel sheet
1 Base steel sheet
2 Insulating coating
21 Intermediate layer
22 Tension coating layer

### INDUSTRIAL APPLICABILITY

According to the embodiment of the present invention, it is possible to provide a grain-oriented electrical steel sheet that is excellent in adhesion with a tension coating and magnetic characteristics, and does not reduce the space factor of a transformer (core). Therefore, the obtained grain-oriented electrical steel sheet can be suitably applied to an iron core material of a transformer, and thus has high industrial applicability.

1. A grain-oriented electrical steel sheet comprising:
a base steel sheet; and
an insulating coating formed on a surface of the base steel sheet, wherein
the insulating coating includes:
an intermediate layer that is formed on a side of the base steel sheet and contains a crystalline metal phosphate; and
a tension coating layer formed on a surface side of the insulating coating, and
the crystalline metal phosphate is plate-shaped, and has an average grain size of 0.5 to 3.0 μm.

2. The grain-oriented electrical steel sheet according to claim 1, wherein, in the intermediate layer, the crystalline metal phosphate includes at least one of zinc phosphate, manganese phosphate, manganese iron phosphate, and calcium zinc phosphate.

3. The grain-oriented electrical steel sheet according to claim 1, wherein the intermediate layer has a thickness of 0.1 to 9.0 μm.

4. A method for forming the insulating coating included in the grain-oriented electrical steel sheet according to claim 1, the method comprising:
a finishing annealing step of applying an annealing separator containing Al₂O₃ in an amount of 10 to 100 mass % onto a steel sheet, drying the steel sheet, and then finishing annealing the steel sheet;
an annealing separator removing step of removing an excess of the annealing separator from the steel sheet after the finishing annealing step;
a light pickling step of pickling the steel sheet after the annealing separator removing step with 0.1 to 10.0 mass % of one inorganic acid of sulfuric acid, chloric acid, nitric acid, and phosphoric acid at a liquid temperature of 20 to 90° C. for 1 to 20 seconds;
an intermediate layer forming step of washing the steel sheet after the light pickling step with water, and then energizing the steel sheet for 3 to 30 seconds at a current density of 1.0 to 50 A/dm² in a mixed treatment liquid having a metal ion concentration of 10 to 50 g/l, a phosphate ion concentration of 10 to 100 g/l, and a nitrate ion concentration of 20 to 80 g/l at a liquid temperature of 30 to 90° C.;
a drying step of pulling up the steel sheet after the intermediate layer forming step from the mixed treatment liquid, removing an excess of the mixed treatment liquid, and then drying the steel sheet; and
a tension coating layer forming step of applying a coating liquid containing a metal phosphate and colloidal silica, the metal phosphate and the colloidal silica contained in a total concentration of 10 to 40 mass %, to the steel sheet after the drying step, drying the steel sheet, and then heating and holding the steel sheet at a sheet temperature of 700 to 950° C. for 10 to 60 seconds.
